(19) United States
(12) Patent Application Publication
(10) Pub. No.: US 2014/0101271 A1
(43) Pub. Date: Apr. 10, 2014

(54) Method and device for pushing network information based on location

(71) Applicant: TENCENT TECHNOLOGY (SHENZHEN) COMPANY LIMITED, Shenzhen (CN)

(72) Inventors: Yu Fan, Shenzhen (CN); Yingjie Wo, Shenzhen (CN); Jian Zhang, Shenzhen (CN); Qingling Yan, Shenzhen (CN); Weiwei Dai, Shenzhen (CN)

(21) Appl. No.: 14/099,597

(22) Filed: Dec. 6, 2013

Related U.S. Application Data
(63) Continuation of application No. PCT/CN2012/080245, filed on Aug. 16, 2012.

(30) Foreign Application Priority Data
Aug. 26, 2011 (CN) 201110248177X

(51) Int. Cl. H04L 12/58

(52) U.S. Cl. CPC H04L 51/20; H04L 51/32
USPC 709/206

(57) ABSTRACT

Disclosed are a method and a device for pushing network information based on a location, which are used for solving the technical problem that an existing system is incapable of pushing network information based on a location. The present disclosure can effectively provide network information within a specific geographical region and drive a user to participate in network information activities, thereby improving the activity of the user to participate in network information interactions. Moreover, a recommendation engine based on a location facilitates the listening of more network information within the geographical region where a user is located, thereby forming a relationship chain with a good value, and further improving the activity of the user to participate in network information interactions.

### CROSS REFERENCE TO RELATED APPLICATIONS

This is a continuation application of International Patent Application No.: PCT/CN2012/080245, filed on Aug. 16, 2012, which claims priority to Chinese Patent Application No.: 201110248177.X, filed on Aug. 26, 2011, the disclosure of which is incorporated by reference herein in its entirety.

### TECHNICAL FIELD

The present disclosure relates to the field of Internet, and more particularly to a method and a device for pushing network information based on a location.

### BACKGROUND

Microblog is a platform for information sharing, transmitting and acquiring based on user relations. A user can build a personal community through the World Wide Web (WEB), Wireless Application Protocol (WAP) and various clients, update information with a text of about 140 characters and realize instantaneous sharing. Microblog, because it is easy to use and can be accessed by various terminals, are popular among users and develops rapidly.

In a microblog system, a first user who sets to “listen to” a second user is willing to receive the information updated instantaneously of the second user. Via various ways, the microblog system will present microblog information published by the second user to the first user (i.e. the subscriber). Therefore, microblog is very timely and effective for users to interact and share information. Thereby, microblog is of great value for commercial promotion and spreading of celebrity influence.

The user of microblog includes plenty of celebrities from every walk of life, or famous enterprises, or famous public institutions (all of these users are called microblog celebrities hereinafter). Common users are able to interact with microblog celebrities through microblog very conveniently. Generally, all existing microblog systems provide a microblog celebrity recommendation function to enable a common user to find the microblog of a microblog celebrity more conveniently. All existing microblog systems generally recommend celebrity microblogs to users randomly, or according to traffic statistics, or by means of background manual editing. A celebrity microblog recommended by a microblog system may be not a user's favorite or concerned celebrity microblog and may not be delivered to a target user. Thus the current demands of users cannot be satisfied, which hampers development of microblog platforms.

### SUMMARY

In view of this, a main purpose of embodiments of the present disclosure is to provide a method and a device for pushing network information based on a location, so as to solve the technical problem that an existing microblog system is incapable of recommending a celebrity microblog based on a location.

To solve the technical problem above, technical solutions of the embodiments of the present disclosure are realized by the following ways.

In Example 1, a method for pushing network information based on a location includes:

storing location information of microblog users;

when receiving a service request from a user, selecting, according to the location information of the user, microblog celebrities with a same geographical region attribute as the user; and

sending information of the selected microblog celebrities to the user with a service response.

In Example 2, the location information of the user initiating the service request of Example 1 may be acquired by the following way:

acquiring an Internet Protocol (IP) address of the user initiating the service request; and

acquiring the location information of the user corresponding to the IP address through an IP-address-to-location-information conversion service.

In Example 3, when the user initiating the service request is a logged-in user, the location information of the user initiating the service request of Example 1 may be acquired by the following way:

acquiring a login account of the user initiating the service request; and

according to the login account, acquiring the location information of the user which is stored in a server when the user registers with the server.

In Example 4, the selecting of Example 1, according to the location information of the user, the microblog celebrities with the same geographical region attribute as the user, may include:

after acquiring the location information of the user initiating the service request, matching, by a server, the location information of the user with location information of microblog celebrities stored in the server, and selecting part of completely-matched or the most matched microblog celebrities as recommended microblog celebrities.

In Example 5, the method of Example 1 may further include: before sending the information of the selected microblog celebrities to the user with the service response:

when the user is a logged-in user, filtering out, by a server, microblog celebrities which have been listened by the logged-in user from the selected microblog celebrities after selecting the recommended microblog celebrities according to the location information of the user.

In Example 6, a device for pushing network information based on a location includes:

a storing module, configured to store location information of microblog users;

a selecting module configured to, when receiving a service request from a user, select, according to location information of the user, microblog celebrities with a same geographical region attribute as the user; and

a feedback module, configured to send information of the selected microblog celebrities to the user with a service response.

In Example 7, the selecting module of Example 6 may include:

a first location information acquiring module, configured to acquire the location information of the user initiating the service request;

a second location information acquiring module, configured to acquire location of microblog celebrities; and

a matching module configured to match the location information of the user with the location information of microblog celebrities, and select part of completely-matched or the most matched microblog celebrities as recommended microblog celebrities.

In Example 8, the first location information acquiring module of Example 7 may include:

a login state determining module configured to determine a login state of the user;

a conversion service module configured to convert an IP address to location information;

a logged-in user location information acquiring module configured to acquire a login account of a logged-in user and acquire location information of the logged-in user which is stored in a server according to the login account; or acquire an IP address of the logged-in user, and acquire location information corresponding to the IP address of the logged-in user through the conversion service module; and

a non-logged-in user location information acquiring module configured to acquire an IP address of a non-logged-in user, and acquire location information corresponding to the IP address of the non-logged-in user through the conversion service module.

In Example 9, the conversion service module of Example 8 may be set in an access layer server, or a server serving the microblog.

In Example 10, the device of Example 6 may further include:

a filtering module, configured to filter out microblog celebrities which have been listened by the user initiating the service request when the user is a logged-in user.

The embodiments of the present disclosure can provide a celebrity recommendation list within a specific region effectively, drive a user to participate in microblog activities and improve interactions and information sharing among users, so as to improve the activity of the user to participate in a microblog. In addition, a recommendation engine based on a location facilitates the listening of more microblog celebrities within the geographical region where the user is located, thereby forming a relationship chain with a good value, and further improving the activity of the user to participate in the microblog.

### BRIEF DESCRIPTION OF THE DRAWINGS

FIG. 1 is a flowchart of a method for pushing network information based on a location according to an embodiment of the present disclosure; and

FIG. 2 is a structural diagram of a microblog celebrity recommendation device based on a location according to an embodiment of the present disclosure.

### DETAILED DESCRIPTION

To make the purposes, technical solutions and advantages of the present disclosure clearer, the present disclosure will be described in details below according to the embodiments and with reference to the accompanying drawings.

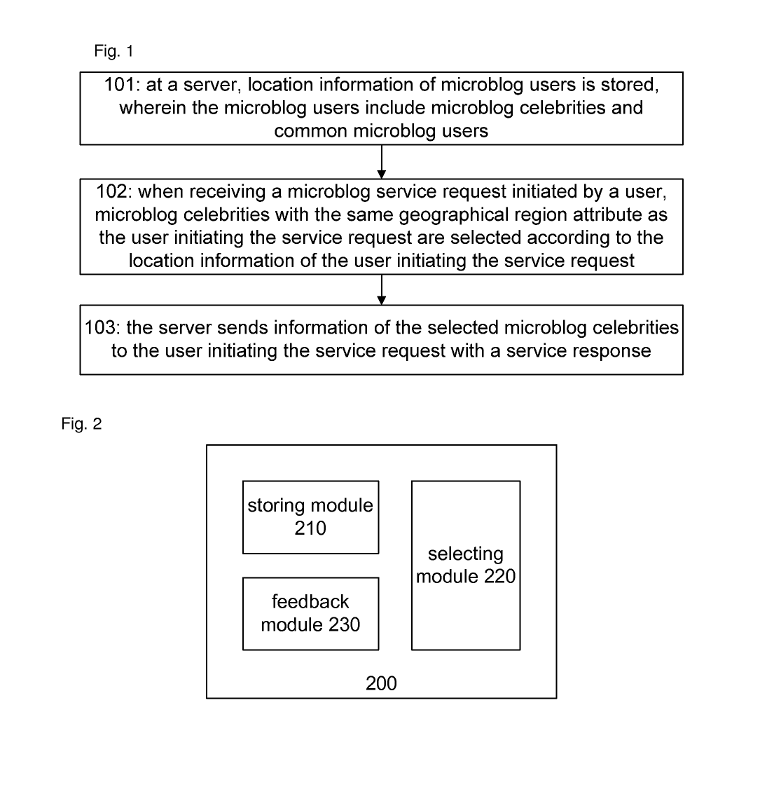

FIG. 1 is a flowchart of a method for pushing network information based on a location according to an embodiment of the present disclosure. As shown in FIG. 1, the method includes steps 101-103.

Step 101: at a server, location information of microblog users is stored, wherein the microblog users include microblog celebrities and common microblog users.

A method for acquiring the location information of the microblog user may include: the user is required to provide its location information when the microblog user registers. A microblog system classifies the geographical region of the microblog user according to the location information registered by the microblog user. The location information includes, but is not limited to: national information, regional information, and administrative region information etc. The administrative region may include: a province, a city, a district, a county and a street etc. A microblog celebrity includes, but is not limited to: a celebrity or a star from every walk of life, a tourist attraction, a place of historic interest, an enterprise and a public institution etc.

Step 102: when receiving a microblog service request initiated by a user, microblog celebrities with the same geographical region attribute as the user initiating the service request are selected according to the location information of the user initiating the service request.

Since the user initiating the microblog service request may be a non-logged-in user, there may be two login states or two login identifiers, of the user initiating the service request, i.e. a logged-in state and a non-logged-in state.

For a logged-in user, a login account of the user initiating the service request may be acquired first, and then the location information registered by the user is acquired from the server according to the login account. Alternatively, according to an IP address of the logged-in user when the request is initiated, the location information of the logged-in user may be also acquired through an IP-address-to-location information conversion service.

For a non-logged-in user, since location information of the non-logged-in user can be acquired only through an IP-address-to-location information conversion service according to an IP address of the user when the request is initiated, and additionally, since there is a huge number of such users, the IP-address-to-location information conversion service may be configured on an access layer server to reduce the load of a back-end server. If the load of the access layer server is relatively heavy, the conversion process may be performed by the server of Step 101.

Step 103: the server sends information of the selected microblog celebrities to the user initiating the service request with a service response.

The server adds microblog information of the selected microblog celebrities with the same geographical region attribute as the user initiating the service request into a feedback page, and recommends the microblog celebrities to the user initiating the service request. The microblog information includes, but is not limited to: a microblog access address, a microblog name and a picture etc. The feedback page includes a microblog celebrity recommendation presenting area, through which area the microblog celebrities selected by the server can be recommended to the user.

A specific selecting method may include: after acquiring the location information of the requesting user, the server matches the location information of the user with the location information of microblog celebrities stored in the server, and selects completely-matched or the most matched microblog celebrities as recommended microblog celebrities. The server may customize a specific selecting rule. The selection may be also performed according to the selecting rule and other attributes of the user so as to improve the precision. Preferably, the microblog celebrities for matching are from a regional microblog celebrity ranking system. The regional microblog celebrity ranking system takes a region to which the microblog celebrities belong as a unit, and popularity of the microblog celebrities are ranked according to microblog traffic. When the matching is performed, a predetermined amount of microblog celebrities with the highest rankings in the same region are acquired from the regional microblog celebrity ranking system to perform the matching.

Further, the method may further include a listening filtering step: for a logged-in user, after selecting the microblog celebrities according to the location information for the user, the server filters out microblog celebrities which have been listened by the logged-in user from the selected microblog celebrities to prevent repeated recommendation.

FIG. 2 is a structural diagram of a microblog celebrity recommendation device based on a location according to an embodiment of the present disclosure. As shown in FIG. 2, the device includes:

a storing module 210, configured to store location information of microblog users;

a selecting module 220 connected with the storing module 210 and configured to, when receiving a service request from a user, select, according to the location information of the user, microblog celebrities with the same geographical region attribute as the user initiating the service request; and

a feedback module 230 connected with the selecting module 220 and configured to send information of the selected microblog celebrities to the user initiating the service request with a service response.

The selecting module 220 may further include:

a first location information acquiring module 221, configured to acquire the location information of the user initiating the service request;

a second location information acquiring module 222, configured to acquire location information of microblog celebrities; and

a matching module 223 configured to match the location information of the user initiating the service request with the location information of the microblog celebrities, and select completely-matched or the most matched microblog celebrities as recommended microblog celebrities.

The first location information acquiring module 221 may further include:

a login state determining module configured to determine a login state of the user initiating the service request;

a conversion service module configured to convert an IP address to location information;

a logged-in user location information acquiring module configured to acquire a login account of a logged-in user and acquire location information of the logged-in user which is stored in a server according to the login account; or acquire an IP address of the logged-in user, and acquire location information corresponding to the IP address of the logged-in user through the conversion service module; and

a non-logged-in user location information acquiring module configured to acquire an IP address of a non-logged-in user, and acquire location information corresponding to the IP address of the non-logged-in user through the conversion service module.

The conversion service module may be set in a server serving the microblog or an access layer server.

Preferably, the device may further include:

a filtering module 240 configured to filter out recommended microblog celebrities which have been listened by the logged-in user initiating the service request.

The above are only preferred embodiments of the present disclosure and not intended to limit the scope of protection of the present disclosure.

1. A method for pushing network information based on a location, comprising:
storing location information of microblog users;
when receiving a service request from a user, selecting, according to the location information of the user, microblog celebrities with a same geographical region attribute as the user; and
sending information of the selected microblog celebrities to the user with a service response.

2. The method according to claim 1, wherein the location information of the user initiating the service request is acquired by the following way:
acquiring an Internet Protocol (IP) address of the user initiating the service request; and
acquiring the location information of the user corresponding to the IP address through an IP-address-to-location-information conversion service.

3. The method according to claim 1, wherein when the user initiating the service request is a logged-in user, the location information of the user initiating the service request is acquired by the following way:
acquiring a login account of the user initiating the service request; and
according to the login account, acquiring the location information of the user which is stored in a server when the user registers with the server.

4. The method according to claim 1, wherein the selecting, according to the location information of the user, the microblog celebrities with the same geographical region attribute as the user, comprises:
after acquiring the location information of the user initiating the service request, matching, by a server, the location information of the user with location information of microblog celebrities stored in the server, and selecting part of completely-matched or the most matched microblog celebrities as recommended microblog celebrities.

5. The method according to claim 1, further comprising: before sending the information of the selected microblog celebrities to the user with the service response:
when the user is a logged-in user, filtering out, by a server, microblog celebrities which have been listened by the logged-in user from the selected microblog celebrities after selecting the recommended microblog celebrities according to the location information of the user.

6. A device for pushing network information based on a location, comprising:
a storing module, configured to store location information of microblog users;
a selecting module configured to, when receiving a service request from a user, select, according to location information of the user, microblog celebrities with a same geographical region attribute as the user; and
a feedback module, configured to send information of the selected microblog celebrities to the user with a service response.

7. The device according to claim 6, wherein the selecting module comprises:
a first location information acquiring module, configured to acquire the location information of the user initiating the service request;
a second location information acquiring module, configured to acquire location of microblog celebrities; and
a matching module configured to match the location information of the user with the location information of microblog celebrities, and select part of completely-matched or the most matched microblog celebrities as recommended microblog celebrities.

8. The device according to claim 7, wherein the first location information acquiring module comprises:
a login state determining module configured to determine a login state of the user;
a conversion service module configured to convert an IP address to location information;
a logged-in user location information acquiring module configured to acquire a login account of a logged-in user and acquire location information of the logged-in user which is stored in a server according to the login account; or acquire an IP address of the logged-in user, and acquire location information corresponding to the IP address of the logged-in user through the conversion service module; and
a non-logged-in user location information acquiring module configured to acquire an IP address of a non-logged-in user, and acquire location information corresponding to the IP address of the non-logged-in user through the conversion service module.

9. The device according to claim 8, wherein the conversion service module is set in an access layer server, or a server serving the microblog.

10. The device according to claim 6, further comprising:
a filtering module, configured to filter out microblog celebrities which have been listened by the user initiating the service request when the user is a logged-in user.

11. The method according to claim 2, wherein the selecting, according to the location information of the user, the microblog celebrities with the same geographical region attribute as the user, comprises:
after acquiring the location information of the user initiating the service request, matching, by a server, the location information of the user with location information of microblog celebrities stored in the server, and selecting part of completely-matched or the most matched microblog celebrities as recommended microblog celebrities.

12. The method according to claim 3, wherein the selecting, according to the location information of the user, the microblog celebrities with the same geographical region attribute as the user, comprises:
after acquiring the location information of the user initiating the service request, matching, by a server, the location information of the user with location information of microblog celebrities stored in the server, and selecting part of completely-matched or the most matched microblog celebrities as recommended microblog celebrities.

13. The method according to claim 2, further comprising: before sending the information of the selected microblog celebrities to the user with the service response:
when the user is a logged-in user, filtering out, by a server, microblog celebrities which have been listened by the logged-in user from the selected microblog celebrities after selecting the recommended microblog celebrities according to the location information of the user.

14. The method according to claim 3, further comprising: before sending the information of the selected microblog celebrities to the user with the service response:
when the user is a logged-in user, filtering out, by a server, microblog celebrities which have been listened by the logged-in user from the selected microblog celebrities after selecting the recommended microblog celebrities according to the location information of the user.

15. The device according to claim 7, further comprising:
a filtering module, configured to filter out microblog celebrities which have been listened by the user initiating the service request when the user is a logged-in user.

16. The device according to claim 8, further comprising:
a filtering module, configured to filter out microblog celebrities which have been listened by the user initiating the service request when the user is a logged-in user.

17. The device according to claim 9, further comprising:
a filtering module, configured to filter out microblog celebrities which have been listened by the user initiating the service request when the user is a logged-in user.
